(19) United States
(12) Patent Application Publication
(10) Pub. No.: US 2025/0082028 A1
(43) Pub. Date: Mar. 13, 2025

(54) HEATING ASSEMBLY AND AEROSOL GENERATION DEVICE

(71) Applicant: SHENZHEN WOODY VAPES TECHNOLOGY CO., LTD., Shenzhen (CN)

(72) Inventors: Xiaohua ZHOU, Shenzhen (CN); Ziyang MA, Shenzhen (CN); Wan LI, Shenzhen (CN); Xiaopeng XIAO, Shenzhen (CN); Ge NIE, Shenzhen (CN)

(73) Assignee: SHENZHEN WOODY VAPES TECHNOLOGY CO., LTD., Shenzhen (CN)

(21) Appl. No.: 18/805,633

(22) Filed: Aug. 15, 2024

(30) Foreign Application Priority Data
Sep. 11, 2023 (CN) 202311170780.X

(51) Int. Cl. A24F 40/46

(52) U.S. Cl. CPC A24F 40/46

(57) ABSTRACT

A heating assembly and an aerosol generation device are provided. The heating assembly includes a heating body. Several heat generation portions serve as a sidewall of the heating body. The several heat generation portions are connected end to end in sequence and at least partially spaced apart from each other. The several heat generation portions that are spaced apart from each other are configured to guide a current to flow along a preset path. The several heat generation portions cooperatively define an accommodating cavity for accommodating an inhalable material and for air circulation.

### CROSS-REFERENCE TO RELATED APPLICATIONS

This application claims priority under 35 U.S.C. § 119 (a) to Chinese Patent Application No. 202311170780.X, filed Sep. 11, 2023, the entire disclosure of which is incorporated herein by reference.

### TECHNICAL FIELD

This disclosure relates to the field of aerosol-generation-device technology, and in particular to a heating assembly and an aerosol generation device.

### BACKGROUND

An existing aerosol generation device includes a nozzle, a heating assembly, and a base in sequence from top to bottom. An air channel that extends from top to bottom is defined in the nozzle, the heating assembly, and the base.

When the aerosol generation device is used, an inhalable material is usually disposed in the air channel of the heating assembly. In this case, since a current of the heating assembly is conducted from a lead access end to the surroundings, different parts of the heating assembly may have different temperatures when the heating assembly heats the inhalation material. As a result, various parts of the inhalable material are heated with different degrees, so that an atomization effect and user experience of the aerosol generation device are affected.

### SUMMARY

In a first aspect, a heating assembly applied to an aerosol generation device. The heating assembly includes a heating body. Several heat generation portions serve as a sidewall of the heating body. The several heat generation portions are connected end to end in sequence and at least partially spaced apart from each other. The several heat generation portions that are at least partially spaced apart from each other are configured to guide a current to flow along a preset path. The several heat generation portions cooperatively define an accommodating cavity for accommodating an inhalable material and for air circulation.

In a second aspect, an aerosol generation device is further provided in the present disclosure. The aerosol generation device includes a heating assembly. The heating assembly includes a heating body. Several heat generation portions serve as a sidewall of the heating body. The several heat generation portions are connected end to end in sequence and at least partially spaced apart from each other. The several heat generation portions that are at least partially spaced apart from each other are configured to guide a current to flow along a preset path. The several heat generation portions cooperatively define an accommodating cavity for accommodating an inhalable material and for air circulation.

### BRIEF DESCRIPTION OF THE DRAWINGS

To describe the solutions in the present disclosure or in the related art more clearly, the following briefly introduces the accompanying drawings required for describing the embodiments or the related art. Apparently, the accompanying drawings in the following description show merely some embodiments of the present disclosure, and those of ordinary skill in the art may still derive other accompanying drawings from these accompanying drawings without creative efforts.

FIG. 1 is a schematic structural view of a heating assembly according to embodiments of the present disclosure.

FIG. 2 is a three-dimensional partial cross-sectional view of the heating assembly in FIG. 1.

FIG. 3 is an exploded schematic view of an aerosol generation device according to embodiments of the present disclosure.

FIG. 4 is a schematic structural view of an aerosol generation device (in a use state) according to embodiments of the present disclosure.

FIG. 5 is a side cross-sectional view of the aerosol generation device (in an unused state) in FIG. 4.

FIG. 6 is a schematic structural view of a lower cover and a flip cover of the aerosol generation device in FIG. 4.

FIG. 7 is a schematic structural view of the flip cover in FIG. 6.

FIG. 8 is a schematic structural view of the flip cover in FIG. 6 from another perspective.

Reference signs in the accompanying drawings are described as follows: support 10, housing 20, inhalable material 30, printed circuit board (PCB) 40, aerosol generation device 50, flip-cover assembly 60, heating assembly 100, heat generation portion 110, gap 111, accommodating cavity 112, insulation filler 113, heating body 120, heat-insulating housing 130, heat-insulating cavity 131, lead 140, first opening 150, second opening 160, base 200, air channel 210, top plate 220, air inlet hole 221, flip cover 300, first recess 310, flip-cover air-inlet-hole 320, second recess 330, first surface 331, second surface 332, reinforcing portion 340, first fixing portion 350, second fixing portion 360, limiting protrusion 370, rotation shaft 410, torsion spring 420, lower cover 500, air outlet 510, second sliding groove 520, upper cover 600, heat dissipation sheet 700, nozzle 800, battery 900.

### DETAILED DESCRIPTION

The following provides a clear and complete description of the technical solution in embodiments of the present disclosure, in conjunction with the accompanying drawings of the embodiments of the present disclosure. It is apparent that the described embodiments are only some of the embodiments of the present disclosure, not all of them. Based on the embodiments of the present disclosure, other embodiments obtained by those skilled in the art without creative effort belong to the scope of the protection of the present disclosure. In addition, it may be understood that specific embodiments described herein are only used to explain and illustrate the present disclosure and are not used to limit the present disclosure.

In the present disclosure, location terms used, such as “up” and “down”, generally indicate up and down in actual using or operating state of devices, in particular drawing directions in the accompanying drawings, unless otherwise described; and “inner” and “outer” refer to contours of devices. In addition, in the description of the present disclosure, a term “include” or “comprise” refers to “include but not limited to”, and a term “more” refers to “two or more than two”. First, second, third, and other terms are used only as indications and do not impose numerical requirements or establish an order.

In the present disclosure, “and/or” describes an association between associated objects, indicating that three relationships may exist. For example, A and/or B may indicate three situations: only A exists, A and B exist at the same time, and only B exists, where A and B each may be singular or plural.

In the present disclosure, “at least one” refers to one or more, and “a plurality of” or “multiple” refers to two or more. “At least one”, “at least one of the following” or similar expressions refer to any combination of these items, including any combination of singular one (item) or plural one (item). For example, “at least one (item) of a, b, or c” or “at least one (item) of a, b, and c” may mean: a, b, c, a-b (that is, a and b), a-c, b-c, or a-b-c, where a, b, and c each may be one or multiple.

Various embodiments of the present disclosure may exist in the form of a range. It may be understood that the description in the form of a range is merely for convenience and conciseness, and may not be construed as a hard limit on the scope of the present disclosure. Accordingly, it may be considered that the description of range may be considered to have specifically disclosed all possible subranges, as well as a single numerical value within the range. For example, it may be considered that the description of a range from 1 to 6 has specifically disclosed subranges, e.g., from 1 to 3, from 1 to 4, from 1 to 5, from 2 to 4, from 2 to 6, from 3 to 6, etc., as well as single numbers within the range, e.g., 1, 2, 3, 4, 5, and 6, which are applicable regardless of the range. In addition, whenever a numerical range is indicated herein, it is meant to include any quoted numbers (fractions or integers) within the indicated range.

A technical problem to be solved by embodiments of the present disclosure is that an existing heating assembly cannot realize an even heating effect.

To solve the above technical problem, a heating assembly that can realize even heating is provided in embodiments of the present disclosure. Technical solutions described below are adopted.

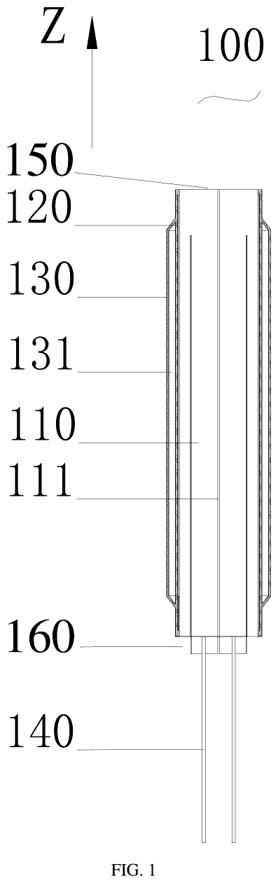

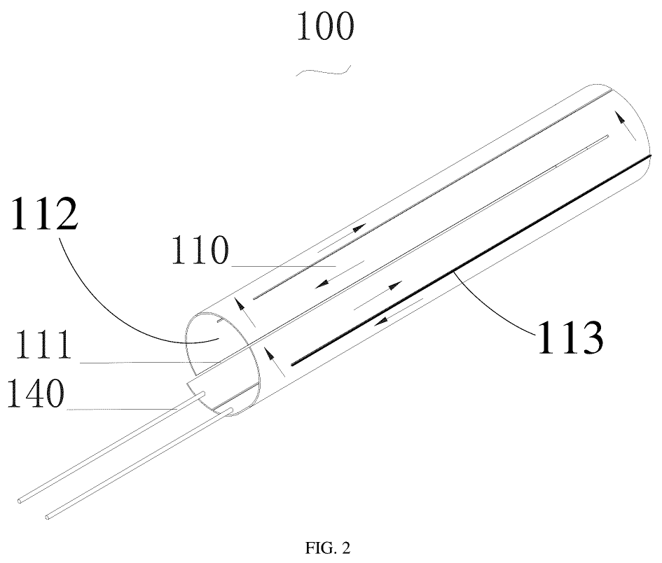

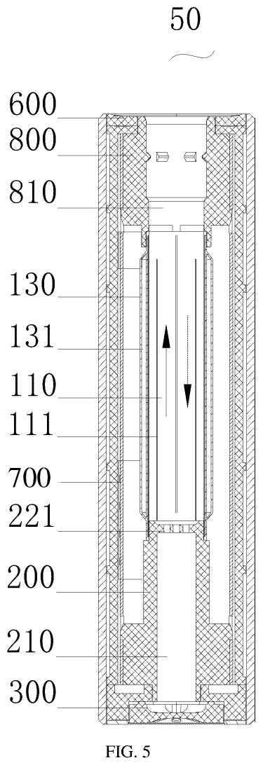

Referring to FIG. 1 to FIG. 5, direction Z in FIG. 1 is an up-down direction. A heating assembly 100 is provided in an embodiment of the present disclosure. The heating assembly 100 includes a heating body 120. Several heat generation portions 110 serve as a sidewall of the heating body 120. The several heat generation portions 110 are connected end to end in sequence and at least partially spaced apart from each other. The several heat generation portions 110 that are at least partially spaced apart from each other are configured to guide a current to flow along a preset path. The several heat generation portions 110 cooperatively define an accommodating cavity for accommodating an inhalable material and for air circulation. Here, in the solution provided in the present disclosure, since the heat generation portions 110 are at least partially spaced apart from each other and the heat generation portions 110 are connected end to end, the heat generation portions 110 can guide the current to flow in a serpentine manner along the heat generation portions 110 according to a preset path shown in FIG. 2. In other words, the current can be distributed throughout the sidewall of the heating body 120 as shown by arrows in FIG. 2 and FIG. 5, so as to achieve the even heating effect for the inhalable material disposed in the accommodating cavity.

Compared with the related art, the embodiments of the present disclosure mainly have following beneficial effects.

Since the heat generation portions are at least partially spaced apart from each other and connected end to end, the heat generation portions can guide the current to flow along the heat generation portions following the preset path. In other words, the current can be distributed throughout the sidewall of the heating body, so as to realize the even heating effect for the inhalable material disposed in the accommodating cavity.

Further, the heating body 120 of the present disclosure defines a first opening 150 for insertion of the inhalable material and a second opening 160 at one end of the heating body 120 opposite to the first opening 150. A gap 111 is defined between every two adjacent heat generation portions 110 of the several heat generation portions 110. The gap 111 has one end extending through the first opening 150 or the second opening 160, and the other end extending to be close to the second opening 160 or the first opening 150.

Referring to FIG. 1 to FIG. 3, the gap 111 includes a first gap, a second gap, and a third gap. The first gap is in communication with an upper edge of the sidewall and a lower edge of the sidewall. The second gap (not labeled in the figures) extends from the upper edge of the sidewall towards the lower edge, but is at a distance from the lower edge, that is, the second gap is not in communication with the lower edge. The third gap extends from the lower edge of the sidewall towards the upper edge, but is at a distance from the upper edge, that is, the third gap is not in communication with the upper edge. The second gap and the third gap are spaced apart from each other. Here, since the gap 111 can block the current, the sidewall of the heating body 120 is defined by the gap 111 to form a current conduction path. In other word, the current may flow in a serpentine manner along the heat generation portions 110, and is distributed throughout the sidewall of the heating body 120, so as to realize the even heating effect for the inhalable material 30 disposed in the accommodating cavity.

It can be understood that, the shape, size, and distribution position of the gap 111 can be adjusted according to the actual needs, as long as the gap 111 can enable the sidewall of the heating body 120 to form the heat generation portions 110 that are connected end to end and at least partially spaced apart from each other. For example, a spiral shaped gap 111 may also be defined in the sidewall, so that the gap 111 extends spirally from the bottom of the sidewall of the heating body 120 to the top of the sidewall, and the sidewall is defined to form a spiral-rising current conduction path. Here, the current can still flow throughout the sidewall of the heating body 120, that is, the even heating effect is realized. If a single current conduction path is adopted, it may result in a relatively slow heating rate of the heating assembly 100, that is, the current takes some time to flow through the entire current conduction path. Therefore, multiple current conduction paths may also be formed on the sidewall due to the gap 111, and multiple leads 140 may be disposed, so that a current can flow in each current conduction path, thereby shortening the distance for the current to flow through, and improving the heating efficiency of the heating assembly 100. A material of the heating body 120 includes, but is not limited to, one of a nickel-chromium alloy, an iron-chromium-aluminum alloy, a stainless steel alloy, palladium, graphene, or a combination thereof.

Referring to FIG. 1 to FIG. 3, the heating body 120 is tubular. The several heat generation portions 110 cooperatively define the accommodating cavity in a circumferential direction of the heating body 120. The several heat generation portions 110 are at least partially spaced apart from each other in the circumferential direction of the heating body 120. A cross section of the accommodating cavity defined in the interior of the heating body 120 may be circular, and may also be triangular, square, and other shapes to adapt to different inhalable materials 30. The accommodating cavity may also be divided into multiple segments, and cross-sectional shapes of the multiple segments of the accommodating cavity varies. Here, the depth at which the inhalable materials 30 of different shapes can enter the accommodating cavity varies, so that a heating range of the inhalation material 30 can be controlled. In this case, the cross section of the accommodating cavity is circular. With equal perimeter, the circle has the largest area, so that the air circulation amount of the heating body 120 of the present disclosure is large. In addition, the air can be evenly distributed on the sidewall of the heating body 120, so that the heating body 120 can evenly heat the air, and the service life of the heating assembly 100 is improved.

For example, the accommodating cavity is divided into two segments from top to bottom, a cross section of an upper segment is circular, and a cross section of a lower segment is equilateral triangle, and a radius of the circle is equal a centerline of the equilateral triangle. Here, the inhalable material 30 includes a first inhalable material and a second inhalable material. A cross section of the first inhalable material is circular. A cross section of a segment of the second inhalable material is equilateral triangle, and a cross section of another segment of the second inhalable material is circular. Therefore, the first inhalable material cannot extend deeply into the lower segment of the accommodating cavity, so that a part of the inhalable material 30 that does not need to be heated can be avoided from being damaged by heating. The second inhalable material can extend deeply into the accommodating cavity, which ensures the heating effect for the inhalable material 30. In summary, the design of the accommodating cavity divided into two segments can control the heating range of the inhalable material 30 and can also be adapted to different inhalable materials 30.

Further, reference can continue to be made to FIG. 1. The heating assembly 100 further includes at least two leads 140. One of the at least two leads 140 is connected to a start end of the several heat generation portions 110, and another of the at least two leads 140 is connected to a terminal end of the several heat generation portions 110. When there is only one current conduction path, a distance through which a current can flow varies with the positions of the two leads 140, that is, the size of the region where the heating assembly 100 can heat varies. In this embodiment of the present disclosure, the two leads 140 are located at the start end of the heat generations portions 110 and the terminal end of end of the heat generations portions 110, respectively. Therefore, the current can flow throughout the sidewall of the heating body 120 of the heating assembly 100, thereby further improving the even heating effect of the heating assembly 100.

Further, referring to FIG. 1 to FIG. 5, the heating assembly 100 further includes a heat-insulating housing 130. The heat-insulating housing 130 is disposed around an outer surface of the heating body 120 for insulating the temperature. When the heating assembly 100 is in operation, the sidewall of the heating body 120 continuously heats. At this time, the heat-insulating housing 130 provided in this embodiment of the present disclosure can prevent the damage to other devices caused by excessive temperature, prevent the user from being scalded, and further improve the heating efficiency of the heating assembly 100 through heat preservation.

It can be understood that the heat-insulating housing 130 may be made of a heat-insulating material, including, but not limited to, any one of aerogel, a ceramic fiber, a silicate material, foam, perlite, expanded graphite, silica aerogel, foamed glass, mineral wool, or a combination thereof. In order to avoid the damage to other devices due to excessive temperature of the heating assembly 100, a heat-insulating structure may also be additionally disposed outside the heating assembly 100. For example, a heat-insulating layer that surrounds the heating assembly 100 is disposed in the aerosol generation device 50, thereby reducing the manufacturing efficiency of the aerosol generation device 50 and making maintenance of the aerosol generation device 50 inconvenient. In contrast, the heat-insulating housing 130 in this embodiment of the present disclosure surrounds the outer surface of the heating body 120, and may be integrated with the heating body 120. Therefore, when the aerosol generation device 50 is assembled, only the heating assembly 100 can be mounted while there is no need to mount a heat-insulating structure, thereby improving the manufacturing efficiency. The heat-insulating housing 130 may also have multiple layers, so as to improve the heat-insulating effect by reducing the heat through the multiple layers.

Further, referring to FIG. 1 to FIG. 5, a heat-insulating cavity is defined in the heat-insulating housing 130. The heat-insulating cavity 131 is disposed around the outer surface of the heating body 120 for insulating the temperature. The heat-insulating housing 130 may be made of a heat-insulating material, and/or the heat-insulating cavity 131 may be defined between the heat-insulating housing 130 and the heating body 120. The heat-insulating cavity 131 is vacuum or filled with an inert gas. If the heat-insulating housing 130 is made of the heat-insulating material, a manufacturing cost of the heating assembly 100 may rise. If the heat-insulating cavity 131 is filled with the inert gas, such as helium or argon, there may also be gas convection in the inert gas, resulting in heat transfer. Meanwhile, there are molecules in the inert gas or air, and these molecules may scatter thermal radiation, thereby affecting the heat-insulating effect. However, when vacuum heat insulation is adopted, since there are no molecules in the vacuum, the gas convection may not cause any influence, and the thermal radiation scattered may be almost negligible. In this embodiment of the present disclosure, the heat-insulating cavity 131 is set to be vacuum, so that the heat-insulating effect of the heating assembly 100 can be further improved, the manufacturing cost can be reduced, the heat loss can be avoided, and the heating effect of the heating assembly 100 can be improved.

Further, the heating body in the related art is generally disposed on an outer wall of a smoke tube, and heats an inhalable material by transferring heat to the inner wall of the smoke tube, so that the energy consumption is relatively high, and there is a relatively large pressure for heat insulation at the periphery of the smoke tube. In this embodiment of the present disclosure, the heating body 120 is in direct contact with the inserted inhalable material 30, so that the inhalable material 30 can be directly heated, the utilization rate of heat can be significantly improved, and the heat loss can be reduced, thereby realizing an energy-saving effect. In addition, the heat-insulating housing 130 is fixed to the heating body 120 at the outer side of the heating body 120. The heat-insulating housing 130 can avoid the heat loss of the heating body 120, so that the heat of the heating body 120 can be fully utilized to heat the inhalable material 30, thereby further improving the heating efficiency and reducing the energy consumption of the aerosol generation device 50. The inhalable material 30 may be a cartridge. The smoke tube may be an assembly defining an air channel.

Multiple recesses (not shown in the figures) may be defined in the heat-insulating cavity 131. Since the vacuum has poorer thermal conductivity than a solid material, when the volume of the heat-insulating cavity 131 is larger, the heat-insulating effect of the heat-insulating cavity 131 will be better. However, simply increasing the volume of the heat-insulating cavity 131 may result in a decrease in the structural strength of the heating assembly 100. When the multiple recesses are defined in the heat-insulating cavity 131 to increase an area of the heat-insulating cavity 131, since the recess just brings about a slight and even structural change, after the recesses are defined in this embodiment of the present disclosure, an internal support point and stability of the heating body 120 or the heat-insulating housing 130 do not change greatly. Therefore, the heat-insulating effect of the heat-insulating cavity 131 can be enhanced, and the strength of the heating assembly 100 can also be avoided from being significantly reduced.

Further, the heating assembly 100 further includes an insulation filler 113. The insulation filler is filled in the gap 111 and is configured to strengthen the heating body 120. Since the sidewall of the heating body 120 defines the gap 111, and the gap 111 may reduce the strength of the heating body 120, in order to avoid deformation of the heating body 120 and the influence on the service life of the heating assembly 100, the gap 111 is filled with the insulation filler 113 in this embodiment of the present disclosure. The material of the insulation filler 113 includes, but is not limited to, any one of rubber, plastic, mica, ceramic, epoxy resin, silicone rubber, polytetrafluoroethylene (PTFE), asbestos, glass fiber, or a combination thereof. When the material of the insulation filler 113 is an insulation material with high temperature resistance such as ceramic, porcelain insulator, epoxy resin, silicone rubber, PTFE, asbestos, glass fiber, and the like, the insulation material can be prevented from melting and becoming ineffective during the operation of the heating assembly 100. It can be understood that the insulation filler 113 may also exceed the gap 111, that is, exceed the sidewall of the heating body 120 towards an axis of the accommodating cavity. In this case, recesses that matches the insulation filler 113 may be defined on a device to-be-heated, so as to realize positioning and fool-proof functions.

Accordingly, an aerosol generation device 50 is further provided in the present disclosure. Referring to FIG. 2 to FIG. 4, the aerosol generation device 50 includes the heating assembly 100 as described above, it can be understood that the aerosol generation device 50 may further include a housing 20, a support 10, an upper cover 600, a lower cover 500, a heat dissipation sheet 700, a nozzle 800, and a printed circuit board (PCB) 40. A third air channel (not labeled in the figures) is defined in the nozzle 800. The third air channel has one end in communication with the accommodating cavity, and the other end in communication with an outside environment. The third air channel, the accommodating cavity, and the air channel 210 can define an air passage that extends through the aerosol generation device 50. The heat dissipation sheet 700 can surround the heating assembly 100 to further dissipate heat escaping from the heating assembly 100. The support 10 is mounted in the housing 20, and the support 10 is limited in the housing 20 by the upper cover 600 and the lower cover 500. The heating assembly 100 is mounted at one side of the support 10, and the battery 900 is mounted at the other side of the support 10. The leads 140 of the heating assembly 100 can be connected to the PCB 40 and the battery 900, so that startup, shutdown, and temperature rising of the heating assembly 100 can be controlled by the PCB 40.

When the aerosol generation device 50 needs to be used, the inhalable material 30 (containing aerosol) can enter the accommodating cavity through the third air channel, so that the heating body 120 surrounds the inhalable material 30. A button is pressed to control the PCB 40 in the aerosol generation device 50, the battery 900 is controlled by the PCB 40 to supply electric energy to the heating body 120 through the lead 140, so that the heating body 120 is continuously heated. The heating body 120 starts to evenly heat the inhalable material 30 from outside to inside. Light waves generated by the heating body 120 are also able to penetrate through the inhalable material 30 to heat the aerosol inside the inhalable material 30. When a user inhales aerosol, normal-temperature air enters the accommodating cavity from the air channel 210 of the base 200, and a high-temperature aerosol substrate is formed inside the accommodating cavity for the user to inhale.

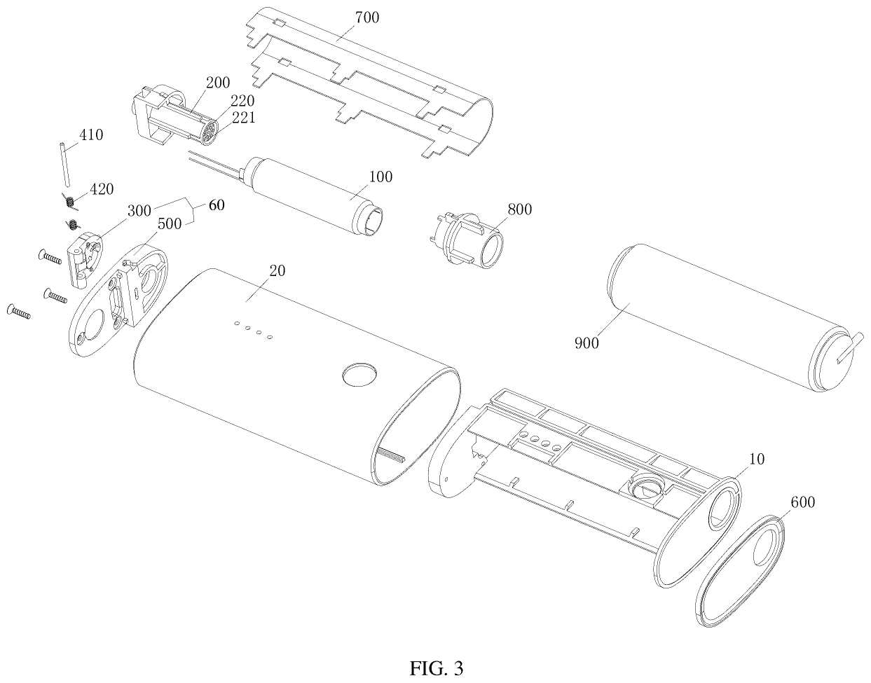

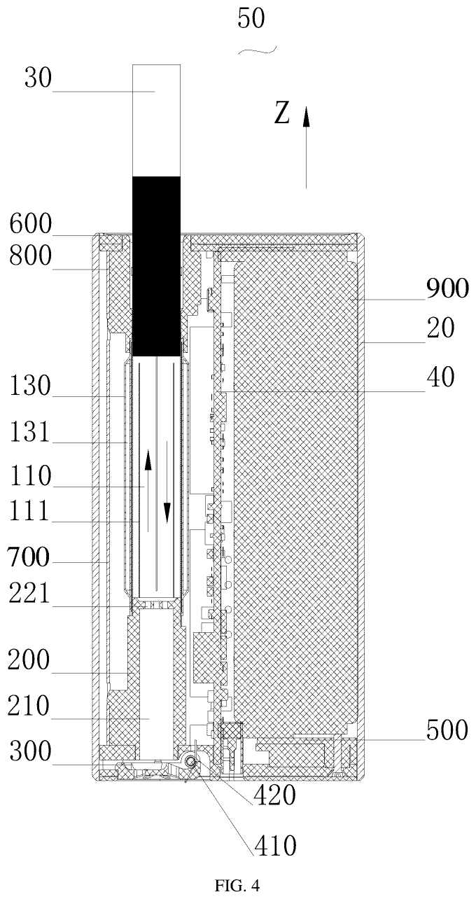

Further, referring to FIG. 3 and FIG. 4, the aerosol generation device 50 further includes a base 200. An air channel 210 is defined in the base 200. The base 200 is provided with a top plate 220. The air channel 210 has one end in communication with the accommodating cavity, and the other end in communication with an outside environment. The top plate 220 is disposed at one end of the base 200 close to the accommodating cavity. Multiple evenly distributed air inlet holes are defined in the top plate 220. The air channel 210 is in communication with the accommodating cavity through the multiple air inlet holes 221. In an aerosol generation device 50 in the related art, when the air circulates, the air is unevenly distributed, which easily leads to uneven heating of the inhalable material 30 and poor user experience. However, in this embodiment of the present disclosure, the multiple evenly distributed air inlet holes 221 are defined in the base 200, so that the air can enter the accommodating cavity from the outside through the air channel 210 and the air inlet holes 221 in the top plate 220 in sequence. When the air passes through the air inlet holes 221, the air will also be evenly divided due to the evenly distributed air inlet holes 221, so that the inhalable material 30 can be evenly heated.

It can be understood that if the inhalable material 30 in the aerosol generation device 50 generates residues after being heated, the air inlet hole 221 can prevent the residues from sliding out from the air channel 210, thereby avoiding affecting the user experience and damaging the environment. Therefore, in the aerosol generation device 50 in this embodiment of the present disclosure, the residues can also be prevented from sliding out from the air channel 210, and the residues can be cleaned by disassembling and mounting the base 200. The even distribution of air may also be controlled by additionally disposing a structure similar to the top plate 220 in the accommodating cavity. However, if this structure is disposed in the accommodating cavity, it may result in the accumulation of residues in the accommodating cavity, which is not easy to clean up. The heating assembly 100 is usually disposed in the interior of the aerosol generation device 50, and cannot be removed and cleaned up, resulting in difficult removing of the residues.

Further, the heating body 120 proposed in the present disclosure is made of a thermosensitive material. In other words, the heating body 120 is a thermosensitive resistor, and the resistance of the thermosensitive resistor varies with temperature. The temperature of the heating body 120 can be measured by using the temperature coefficient of resistance of the thermosensitive material. Specifically, the heating body 120 cannot only be used as a heating element, but also can cooperate with the lead 140 and the PCB 40 to measure the heating temperature. During operation, one end of the lead 140 is connected to the heating body 120, and the other end of the lead 140 is connected to the PCB 40. The heating temperature of the heating body 120 is obtained by measuring the resistance of the heating body 120. It can be seen that the heating body 120 provided in the present disclosure can heat and measure the temperature, so that the structure can be simplified and the cost can be reduced.

Further, referring to FIG. 3, the air inlet holes 221 are stacked in a radial direction of the air channel 210 and axisymmetrically distributed, that is, the multiple air inlet holes 221 are stacked and nested in a multi-layered annular shape. Compared with other distribution forms such as a matrix distribution or a polygonal distribution of the air inlet holes 221, the distribution of the air inlet holes 221 in this embodiment of the present disclosure can be adapted to the cross-sectional shape of the accommodating cavity, allowing the air to flow into the accommodating cavity more evenly and proportionally, thereby further improving the even heating effect of the aerosol generation device 50.

Further, referring to FIG. 3 to FIG. 5, the aerosol generation device 50 further includes an atomization body and a flip cover 300. The flip cover 300 is rotatably connected to one end of the atomization body away from the accommodating cavity, and is rotatable for controlling opening and closing of the air channel 210. During the use of the aerosol generation device 50, dusts often enter the accommodating cavity and the air channel 210 due to a long period of non-use, so that the heating effect of the aerosol generation device 50 and the user experience will be seriously affected. The rotatable flip cover 300 is additionally disposed in this embodiment of the present disclosure, so that the flip cover 300 can be flipped over to open or close the accommodating cavity, thereby enabling the user to clean the accommodating cavity, and avoiding the entry of dusts. It can be understood that another flip cover 300 may further be disposed on the nozzle 800. By controlling the flip cover 300 on the base 200 and the flip cover 300 on the nozzle 800, the accommodating cavity and the air channel 210 can be completely closed, thereby further avoiding contamination of the accommodating cavity and the air channel 210 by the outside environment. It can be understood that the rotational connection manner of the flip cover 300 is not limited to a bearing, a sliding bearing, a shaft, a hinge, etc.

Further, referring to FIG. 3 to FIG. 4, the aerosol generation device 50 further includes a rotation shaft 410 and a torsion spring 420. The rotation shaft 410 passes through the flip cover 300 and the torsion spring 420. The torsion spring 420 has one end abutting against the flip cover 300 and the other end abutting against the atomization body. The torsion spring 420 is configured to reset the flip cover 300. When the flip cover 300 is flipped over, the user often needs to operate the flip cover 300 again to reset the flip cover 300, resulting in low use efficiency of the aerosol generation device 50. By additionally disposing the torsion spring 420 in this embodiment of the present disclosure, the two ends of the torsion spring 420 abut against the flip cover 300 and the atomization body respectively. Therefore, during operation of the flip cover 300, the flip cover 300 can be reset due to the recovery of the elastic deformation of the torsion spring 420, and mutual reset is not required, thereby improving the use efficiency of the aerosol generation device 50. It can be understood that the reset of the flip cover 300 may also be realized by means of an ordinary spring, an elastic member, or the like. For example, a spring is disposed at one end of the flip cover 300 away from the rotation shaft 410, and the spring has one end abutting against the flip cover 300 and the other end abutting against the atomization body, so that flip cover 300 can realize a reset function, but the spring may affect an effect of airflow circulation of the accommodating cavity. The atomization body may be the housing 20 in FIG. 3, or a device such as the lower cover 500.

Further, in this embodiment, the flip cover 300 and the lower cover 500 together constitute a flip-cover assembly 60. The flip-cover assembly 60 allows external air to enter the air channel 210, so that aerosol generated by atomization in the heating assembly 100 is carried out from the nozzle by the air in the air channel 210 during inhalation of the user, and the aerosol is available for the user to inhale.

In some embodiments, the lower cover 500 defines an air outlet 510. In a direction from the flip cover 300 to the air channel 210, that is, in a direction from one end of the air channel 210 close to the flip cover 300 to other end of the air channel 210 away from the flip cover 300, an inner diameter of the air channel 210 gradually increases. In this way, the air entering the air channel 210 from a second recess 330 is diffused, thereby improving the flow efficiency of the air in the air channel 210, and further improving the air outlet efficiency of the air outlet 510.

In order to enable those skilled in the art to better understand the solution of the present disclosure, the technical solution of the flip-cover assembly 60 in embodiments of the present disclosure will be clearly and completely described below in conjunction with the accompanying drawings.

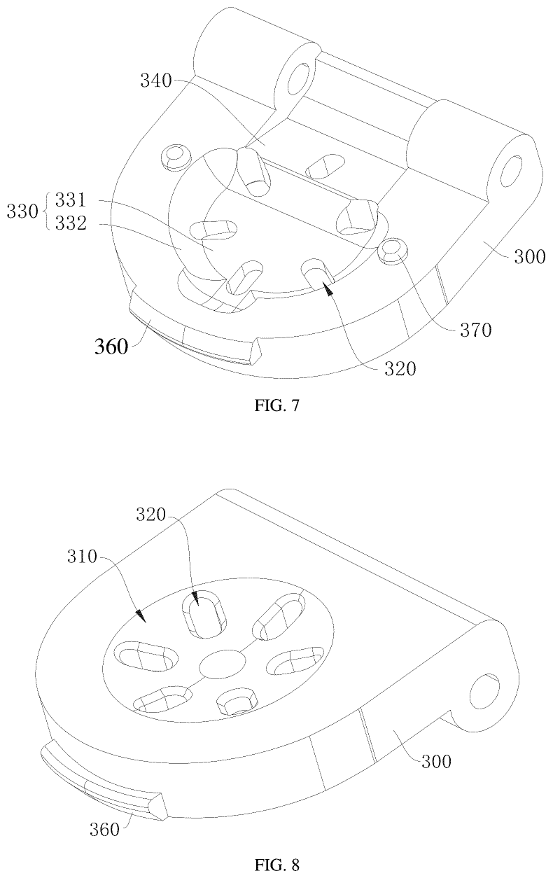

Referring to FIG. 3 to FIG. 8, a flip-cover assembly 60 is provided in embodiments of the present disclosure. The flip-cover assembly 60 is applied to the aerosol generation device 10. The flip-cover assembly 60 includes a lower cover 500 and a flip cover 300. The flip cover 300 is disposed on the lower cover 500.

The lower cover 500 defines an air outlet 510. The flip cover 300 is configured to cover an air inlet end of the air outlet 510. In a direction from the flip cover 300 to the air outlet 510, that is, in a direction from one end the flip cover 300 away from the lower cover 500 to the other end of the flip cover 300 close to the lower cover 500, the flip cover 300 defines a first recess 310, a flip-cover air-inlet-hole 320, and a second recess 330 in sequence. The first recess 310, the flip-cover air-inlet-hole 320, the second recess 330, and the air outlet 510 are in communication with one another.

It can be understood that in the present disclosure, the external air can pass through the first recess 310, the flip-cover air-inlet-hole 320, and the second recess 330 in sequence, and then enter the air outlet 510.

The first recess 310 is defined at one end of the flip cover 300 away from the lower cover 500, and the second recess 330 is defined at the other end of the flip cover 300 close to the lower cover 500, so that the flip cover 300 is thinned, and a raw material for manufacturing the flip cover 300 is reduced, thereby facilitating the miniaturization of the aerosol generation device 10 to which the flip-cover assembly 60 in this embodiment of the present disclosure is applied. In addition, the first recess 310 and the second 330 on the thinned flip cover 300 respectively form a staggered step structure with the flip cover 300, so that the external air is easier to converge at the first recess 310, and the air in the flip-cover air-inlet-hole 320 is easier to flow out of the second recess 330. Therefore, the air inlet efficiency and air outlet efficiency of the flip-cover assembly 60 can be improved, thereby improving the atomization effect of the aerosol generation device 10 to which the flip-cover assembly 60 in the present disclosure is applied.

In some embodiments, referring to FIG. 4 and FIG. 8, the first recess 310 is an air compression groove for allowing the external air to be compressed and guided into the flip-cover air-inlet-hole 320.

It can be understood that, in order to reduce external dusts, foreign matters, etc., from entering the flip-cover air-inlet-hole 320, the flip-cover air-inlet-hole 320 has a smaller size than the first recess 310. In the present disclosure, in a process of the external air entering the flip-cover air-inlet-hole 320, the external air is compressed by means of the air compression groove, so as to reduce the volume of the external air, so that the external air is easier to enter the flip-cover air-inlet-hole 320, thereby improving the air inlet efficiency of the external air into the flip-cover air-inlet-hole 320, and improving the inhalation effect of the aerosol generation device 10 to which the flip-cover assembly 60 in this embodiment of the present disclosure is applied.

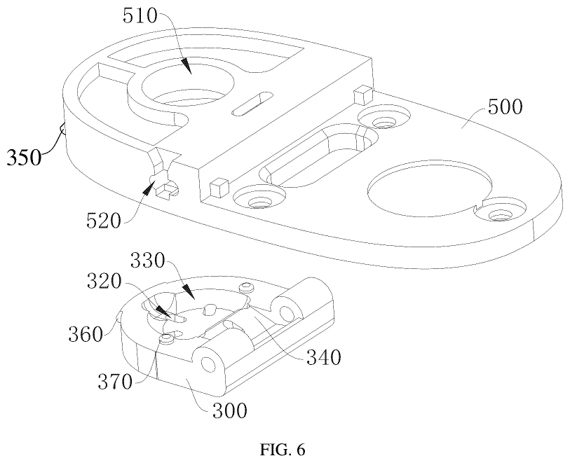

In some embodiments, referring to FIG. 6 to FIG. 8, in a direction from the flip cover 300 to the air outlet 510, that is, in a direction from one end of the first recess 310 away from the lower cover 500 to the other end of the first recess 310 close to the lower cover 500, an inner diameter of the air compression groove gradually decreases.

In this embodiment, the air compression groove has an air inlet end that is in communication with the external atmosphere and an air outlet end that is in communication with an air inlet end of the flip-cover air-inlet-hole 320. An inner diameter of the air inlet end of the air compression groove is larger than an inner diameter of the air outlet end of the air compression groove. It can be understood that, the air inlet end of the air compression groove with a larger inner diameter allows more external air to enter, thereby ensuring the inlet volume of the external air. In addition, during the flow of the external air from the air inlet end of the air compression groove to the air outlet end of the air compression groove, the external air is gradually compressed, so that the volume of the external air is reduced, and the external air is guided to flow towards the air inlet end of the flip-cover air-inlet-hole 320. Therefore, it is beneficial for the external air to enter the flip-cover air-inlet-hole 320, so that the air inlet efficiency of the external air into the flip-cover air-inlet-hole 320 is effectively improved.

In some embodiments, referring to FIG. 6 and FIG. 8, the second recess 330 is an air diffusion groove for allowing the air in flip-cover air-inlet-hole 320 to be diffused and guided into air outlet 510.

In this embodiment, the air diffusion groove is utilized to diffuse the air flowing out of the air outlet end of the flip-cover air-inlet-hole 320 to flow, thereby improving the flow efficiency of the air flowing out of the flip-cover air-inlet-hole 320, realizing diffusion and export of the air in the flip-cover air-inlet-hole 320, and improving the air outlet efficiency of the flip-cover air-inlet-hole 320. In addition, due to the acceleration of the air outlet efficiency at the air outlet end of the flip-cover air-inlet-hole 320, a pressure at the air inlet end of the flip-cover air-inlet-hole 320 is lower than a pressure at the air outlet end of the flip-cover air-inlet-hole 320, so that the flow of the air in the flip-cover air-inlet-hole 320 is promoted, and the air inlet efficiency of the external air flowing into the flip-cover air-inlet-hole 320 is improved.

In some embodiments, referring to FIG. 4 to FIG. 6, in a direction from the flip cover 300 to the air outlet 510, that is, in a direction from one end of the second recess 320 away from the lower cover 500 to the other end of the second recess 320 close to the lower cover 500, an inner diameter of the air diffusion groove gradually increases.

In this embodiment, the air diffusion groove has an air inlet end that is in communication with the air outlet end of the flip-cover air-inlet-hole 320 and an air outlet end that is in communication with the air inlet end of the air outlet end 510. The inner diameter of the air inlet end of the air diffusion groove is smaller than the inner diameter of the air outlet end. It can be understood that, the inner diameter of the air diffusion groove from the air inlet end to the air outlet end gradually increases, so that the air outlet amount of the air diffusion groove gradually increases in a direction from the air inlet end of the air diffusion groove to the air outlet end of the air diffusion groove, and the discharge of the air in the flip-cover air-inlet-hole 320 can be accelerated. Therefore, the flow efficiency of the air in the flip-cover air-inlet-hole 320 is improved, thereby improving the air inlet efficiency and the air outlet efficiency of the flip-cover air-inlet-hole 320.

In some embodiments, referring to FIG. 4 to FIG. 8, a depth ratio of the first recess 310 to the second recess 330 ranges from 0.3 to 1. In this range, as the depth ratio of the first recess 310 to the second recess 330 gradually increases, the air outlet efficiency of the air in the flip-cover air-inlet hole 320 that enters the second recess 330 is gradually balanced with the air inlet efficiency of the external air that enters the flip-cover air-inlet-hole 320 through the first recess 310. Therefore, the atomization effect of the aerosol generation device 10 to which the flip-cover assembly 60 in the present disclosure is applied is ensured.

Optionally, the depth ratio of the first recess 310 to the second recess 330 is selected from any one of 0.3, 0.4, 0.5, 0.6, 0.7, 0.8, 0.9, and 1, or a range formed by any two thereof.

In some embodiments, referring to FIG. 4 to FIG. 8, there are at least three flip-cover air-inlet-holes 320. Various flip-cover air-inlet-holes 320 are defined around the center of the first recess 310. In this way, external air can enter the second recess 330 from the first recess 310 through the flip-cover air-inlet-holes 320 in different directions, thereby effectively improving the air inlet amount and air outlet amount of the flip-cover air-inlet-holes 320.

Preferably, there are six flip-cover air-inlet-holes 320. The six flip-cover air-inlet-holes 320 are arranged in an array around the center of the first recess 310, so that the first recess 310 defines the flip-cover air-inlet-holes 320 in various directions. Therefore, after the external air enters the first recess 310, the external air can enter the flip-cover air-inlet-holes 320 from the first recess 310 in different directions, thereby effectively increasing the air inlet amount of the flip-cover air-inlet-holes 320. In addition, the air in the flip-cover air-inlet-holes 320 may also enter the second recess 330 in different directions, thereby effectively increasing the air outlet amount of the flip-cover air-inlet-holes 320.

In some embodiments, referring to FIG. 6 to FIG. 8, the second recess 330 has a first surface 331 and a second surface 332 connected to the first surface 331. The second surface 332 surrounds the first surface 331. The flip-cover assembly 60 further includes a reinforcing portion 340. The reinforcing portion 340 is connected and fixed to each of the first surface 331 and the second surface 332.

It can be understood that, since the first recess 310 and the second recess 330 are defined on the flip cover 300, the structural strength of the flip cover 300 is reduced. In this embodiment, the reinforcing portion 340 is connected to the first surface 331 of the second recess 330 and the second surface 332 of the second recess 330, so that the structural strength as well as impact resistance at the reinforcing portion 340 in the second recess 330 are improved, thereby prolonging the service life of the flip cover 300.

In some embodiments, referring to FIG. 6 to FIG. 8, there is at least one reinforcing portions 340. The structural strength of the flip cover 300 increases as the number of the reinforcing portions 340 increases.

Preferably, there are two reinforcing portions 340. The two reinforcing portions 340 are disposed opposite to each other in the second recess 330. In this way, the two reinforcing portions 340 cannot only further improve the structural strength of the flip cover 300, but also avoid the reinforcing portions 340 from occupying too much space in the second recess 330, thereby ensuring the air outlet amount of the second recess 330, and ensuring the air inlet amount of the air outlet 510.

In some embodiments, referring to FIG. 6 to FIG. 8, the flip-cover assembly 60 further includes a switching structure. The switching structure is disposed between the flip cover 300 and the lower cover 500. The flip cover 300 is rotatably connected to the lower cover 500. The switching structure is configured to drive the flip cover 300 to open or close the air inlet end of the air outlet 510.

In this embodiment, the switching structure can cause the flip cover 300 to close and seal the air inlet end of the air outlet 510, thereby reducing dusts, foreign matters, etc., from entering the air channel 210 from the air outlet 510. The switching structure may also drive the flip cover 300 to open the air inlet end of the air outlet 510 to clean the inside of the air outlet 510, thereby ensuring the inhalation effect of the aerosol generation device 10 to which the flip-cover assembly 60 in this embodiment of the present disclosure is applied.

In some embodiments, the air outlet 510 is a mounting opening for connection to the base 200, thereby realizing communication between the air channel 210 and the second recess 330.

In some embodiments, referring to FIG. 4 and FIG. 8, the flip cover 300 is provided with a limiting protrusion 370 on one surface of the flip cover 300 facing the lower cover 500, or the lower cover 500 is provided with a limiting protrusion 370 on one surface of the lower cover 500 facing the flip cover 300, where the limiting protrusion 370 is configured to limiting a covering position of the flip cover 300. Therefore, the accuracy of the covering position of the flip cover 300 can be ensured.

In some embodiments, referring to FIG. 2 to FIG. 8, the lower cover 500 defines a first sliding groove (not labeled in the figures). The flip cover 300 is slidably mounted in the first sliding groove. The switching structure includes a driving member (not labeled in the figures), and a first fixing portion 350 and a second fixing portion 360 cooperating with each other in use. An output end of the driving member is connected to the flip cover 300. The first fixing portion 350 is mounted on the lower cover 500, and the second fixing portion 360 is mounted on the flip cover 300.

In this embodiment, when the first fixing portion 350 and the second fixing portion 360 are cooperatively connected, the flip cover 300 covers the air inlet end of the air outlet 510. When the flip cover 300 slides in the first sliding groove in a direction away from the first fixing portion 350, the second fixing portion 360 on the flip cover 300 is separated from the first fixing portion 350 on the lower cover 500, so that the flip cover 300 is driven by the driving member to open the air inlet end of the air outlet 510.

In some embodiments, referring to FIG. 4 to FIG. 8, the first recess 310 on the flip cover 300 may facilitate an operator to push the flip cover 300 to slide in the first sliding groove, thereby improving the convenience of operation.

In some embodiments, the first fixing portion 350 and the second fixing portion 360 may be connected in a cooperative manner including, but not limited to, snap-fit connection, plug-in connection, mortise and tenon connection, and the like.

Preferably, the first fixing portion 350 is cooperatively connected to the second fixing portion 360 by means of snap-fit connection. One of the first fixing portion 350 and the second fixing portion 360 is a snap and the other of the first fixing portion 350 and the second fixing portion 360 is a slot. The flip cover 300 covers the air inlet end of the air outlet 510 by means of the snap fit between the snap and the slot.

In some embodiments, the second fixing portion 360 may be disposed at one end or a side surface of the flip cover 300, which is not specifically limited herein.

For example, if the second fixing portion 360 is disposed at one end of the flip cover 300, and the lower cover 500 is rotatably connected to the other end of the flip cover 300. In actual application, when the flip cover 300 slides in the first sliding groove, the flip cover 300 can move towards or away from the first fixing portion 350, so as to facilitate the connection and separation of the second fixing portion 360 on the flip cover 300 and the first fixing portion 350 on the lower cover 500. If the second fixing portion 360 is disposed on the side surface of the flip cover 300, a larger first sliding groove can be defined on the lower cover 500, so as to provide sufficient space for the flip cover 300 to slide.

Further, when the second fixing portion 360 is disposed on the side surface of the flip cover 300, there may be multiple sets of the first fixing portion 350 and the second fixing portion 360, and the multiple sets of the first fixing portion 350 and the second fixing portion 360 are distributed on both sides of the flip cover 300.

In some embodiments, the flip cover 300 is rotatably connected to the lower cover 500 through a rotation shaft. The lower cover 500 defines a second sliding groove 520. The rotation shaft is slidably mounted in the second sliding groove 520, and a sliding direction of the rotation shaft is parallel to a sliding direction of the flip cover 300. In this way, the flip cover 300 can realize both rotating and sliding.

In some embodiments, the driving member is a torsion spring. The driving member is sleeved on the rotation shaft. An output end of the torsion spring is connected to one end of the flip cover 300 close to the air outlet 510.

It can be understood that, when the first fixing portion 350 is connected to the second fixing portion 360 to limit the flip cover 300, so that the flip cover 300 covers the air inlet end of the air outlet 510, and the torsion spring is compressed by the flip cover 300 to store energy. When the first fixing portion 350 is separated from the second fixing portion 360, the flip cover 300 is not limited, the torsion spring drives the flip cover 300 to rotate and open by using the energy stored in the torsion spring, thereby realizing automatic opening of the flip cover 300.

It is apparent that the embodiments described above are only some embodiments of the present disclosure, but not all embodiments of the present disclosure, and that the accompanying drawings illustrate exemplary embodiments of the present disclosure but do not limit the scope of the present disclosure. The present disclosure may be embodied in many different forms and, on the contrary, these embodiments are provided so that disclosures in the present disclosure are thoroughly and completely understood. Although the present disclosure has been described in detail with reference to the above embodiments, those skilled in the art will be able to make modifications to the technical solutions disclosed in the specific embodiments or make equivalent substitutions for some of the technical features. Where an equivalent structure made by using the contents of the specification and the accompanying drawings of the present disclosure is directly or indirectly applied to other relevant technical fields, it is likewise within the scope of protection of the present disclosure.

Although embodiments of the present application have been illustrated and described, it can be appreciated by those skilled in the art that changes, modifications, combinations, alternatives, and modifications can be made to these embodiments without departing from the principle and spirit of the present disclosure, and the scope of the present disclosure is defined by the claims and equivalents thereof.

What is claimed is:

1. A heating assembly applied to an aerosol generation device, comprising a heating body, wherein several heat generation portions serve as a sidewall of the heating body, the several heat generation portions are connected end to end in sequence and at least partially spaced apart from each other, the several heat generation portions that are at least partially spaced apart from each other are configured to guide a current to flow along a preset path, and the several heat generation portions cooperatively define an accommodating cavity for accommodating an inhalable material and for air circulation.

2. The heating assembly of claim 1, wherein the heating body is tubular, the several heat generation portions cooperatively define the accommodating cavity in a circumferential direction of the heating body, and the several heat generation portions are at least partially spaced apart from each other in the circumferential direction of the heating body.

3. The heating assembly of claim 2, wherein the heating body defines a first opening for insertion of the inhalable material and a second opening at one end of the heating body opposite to first opening, a gap is defined between every two adjacent heat generation portions of the several heat generation portions, and the gap has one end extending through the first opening or the second opening, and the other end extending to be close to the second opening or the first opening.

4. The heating assembly of claim 3 further comprising an insulation filler disposed in the gap, wherein the insulation filler is configured to strengthen the heating body.

5. The heating assembly of claim 1 further comprising at least two leads, wherein one of the at least two leads is connected to a start end of the several heat generation portions, and another of the at least two leads is connected to a terminal end of the several heat generation portions.

6. The heating assembly of claim 1 further comprising a heat-insulating housing, wherein the heat-insulating housing is disposed around an outer surface of the heating body; and
the heat-insulating housing defines a heat-insulating cavity around the heating body.

7. The heating assembly of claim 1, wherein the heating body is made of a thermosensitive material.

8. An aerosol generation device comprising a heating assembly, wherein the heating assembly applied to an aerosol generation device, comprising a heating body, wherein several heat generation portions serve as a sidewall of the heating body, the several heat generation portions are connected end to end in sequence and at least partially spaced apart from each other, the several heat generation portions that are at least partially spaced apart from each other are configured to guide a current to flow along a preset path, and the several heat generation portions cooperatively define an accommodating cavity for accommodating an inhalable material and for air circulation.

9. The aerosol generation device of claim 8 further comprising a base, wherein an air channel is defined in the base, the base is provided with a top plate, and the air channel has one end in communication with the accommodating cavity and the other end in communication with an outside; and
the top plate is disposed at one end of the base close to the accommodating cavity, a plurality of evenly distributed air inlet holes are defined in the top plate, and the air channel is in communication with the accommodating cavity through the plurality of air inlet holes.

10. The aerosol generation device of claim 8 further comprising an atomization body and a flip cover, wherein the flip cover is rotatably connected to one end of the atomization body away from the accommodating cavity, and is rotatable for controlling opening and closing of the air channel.

11. The aerosol generation device of claim 10, wherein in a direction from one end of the air channel close to the flip cover to other end of the air channel away from the flip cover, an inner diameter of the air channel gradually increases.

12. The aerosol generation device of claim 10 further comprising a rotation shaft and a torsion spring, wherein the rotation shaft passes through the flip cover and torsion spring, the torsion spring has one end abutting against the flip cover and the other end abutting against the atomization body, and the torsion spring is configured to reset the flip cover.

13. The aerosol generation device of claim 10 further comprising a housing, a support, an upper cover, a lower cover, and a heat dissipation sheet, wherein the heat dissipation sheet surrounds the heating assembly, the support is mounted in the housing, and the support is limited in the housing by the upper cover and the lower cover.

14. The aerosol generation device of claim 13, wherein the flip cover is provided with a limiting protrusion on one surface of the flip cover facing the lower cover, or the lower cover is provided with a limiting protrusion on one surface of the lower cover facing the flip cover.

15. The aerosol generation device of claim 13, wherein the flip cover is disposed on the lower cover; the lower cover defines an air outlet, the flip cover is configured to cover an air inlet end of the air outlet; in a direction from one end the flip cover away from the lower cover to the other end of the flip cover close to the lower cover, the flip cover defines a first recess, a flip-cover air-inlet-hole, and a second recess in sequence; and the first recess, the flip-cover air-inlet-hole, the second recess, and the air outlet are in communication with one another.

16. The aerosol generation device of claim 15, wherein in a direction from one end of the first recess away from the lower cover to the other end of the first recess close to the lower cover, an inner diameter of the first recess gradually decreases.

17. The aerosol generation device of claim 15, wherein in a direction from one end of the second recess away from the lower cover to the other end of the second recess close to the lower cover, an inner diameter of the second recess gradually increases.

18. The aerosol generation device of claim 15, wherein a depth ratio of the first recess to the second recess ranges from 0.3 to 1.

19. The aerosol generation device of claim 15 further comprising a reinforcing portion, wherein the second recess has a first surface and a second surface connected to the first surface, the second surface surrounds the first surface, and the reinforcing portion is connected and fixed to each of the first surface and the second surface.

20. The aerosol generation device of claim 15 further comprising a first fixing portion and a second fixing portion cooperating with each other, wherein the first fixing portion is mounted on the lower cover, and the second fixing portion is mounted on the flip cover.
